(19) United States
(12) Patent Application Publication
(10) Pub. No.: US 2018/0304771 A1
(43) Pub. Date: Oct. 25, 2018

(54) METHOD FOR ADJUSTING A SEAT OF A VEHICLE

(71) Applicant: Ford Global Technologies, LLC, Dearborn, MI (US)

(72) Inventors: Philipp Wolf, Cologne (DE); Nikica Hennes, Aachen (DE); Jeroen Lem, Maastricht (NL)

(73) Assignee: Ford Global Technologies, LLC, Dearborn, MI (US)

(21) Appl. No.: 15/896,346

(22) Filed: Feb. 14, 2018

(30) Foreign Application Priority Data
Apr. 21, 2017 (DE) 102017206726.8

(51) Int. Cl. B60N 2/02; B60N 2/00; B60R 16/037

(52) U.S. Cl. CPC B60N 2/0232; B60R 16/037; B60N 2/002

(57) ABSTRACT

A method for operating a vehicle is provided. The method includes the steps of sensing a state parameter, and selecting a seat position for a seat of the vehicle from a plurality of seat positions, in dependence on the state parameter.

### FIELD OF THE INVENTION

The present invention generally relates to vehicle seats, and more particularly relates to a method of adjusting a vehicle seat.

### BACKGROUND OF THE INVENTION

Actions and activities of a driver of a vehicle vary according to the situation, task or time. Depending on the actions and activities, differing seat positions may be appropriate for the driver. For example, the position of the seat or of a steering wheel may adjusted. However, other systems also, such as air cushions in the seat, lumbar supports, a foot rest, a foot support, pedals, device mounting, mirrors or arm rests may result in a different sitting posture.

Differing seat positions may be appropriate, depending on the task, for example in the case of a journey with activated speed control, reading or sleeping, travel on a freeway with few bends, or intra-urban journeys with many bends, and short or long journey.

As a result of the emergence of self-driving vehicles, the number of scenarios with differing seat positions will increase, especially during a transition phase in which, because of semi-autonomy, it may be necessary for the driver to assume control of the vehicle. In this case, the driver must be brought into a driver's seat position when taking control of the vehicle, and possibly brought back into the initial position.

It would be desirable to implement ways in which a seat position can be adapted in dependence on a situation.

### SUMMARY OF THE INVENTION

According to one embodiment of the present invention, a method for adjusting a seat of a vehicle is provided. The method includes the steps of sensing a state parameter, selecting a seat position for the seat from a plurality of seat positions, in dependence on the state parameter, and adjusting the seat to the selected seat position.

The sensing of a state parameter in this embodiment may be effected, or activated, automatically or manually. Further, both the selection and the initialization, or setting, of a seat position from a plurality of seat positions may be performed manually or automatically.

The plurality of seat positions differs, for example, in respect of the backrest of the seat. Thus, by sensing and evaluation of the state parameter, a seat position adapted to the respective situation can be provided.

According to one embodiment, the state parameter is representative of at least one of a requested driver intervention, a traffic situation, a journey duration, and a driver action. The requested driver intervention requests the driver to assume control of the vehicle. A traffic situation may be intra-urban traffic or a freeway journey, the journey duration may be a short-distance or a long-distance journey, and actions may be, for example, the activating of a smartphone. Further, it may be a journey with activated speed control. According to a further embodiment, if the vehicle is travelling autonomously in a semiautomatic operating mode, upon a requested driver intervention, a driver's seat position is selected from the plurality of seat positions. A driver's seat position in this case is understood to mean a seat position in which the driver guides the vehicle. It is thus made possible for the driver to properly operate the pedals for acceleration, brake and, if appropriate, clutch of the vehicle, if it is necessary for the driver to assume control of the vehicle.

According to a further embodiment, at least one seat position of the plurality of seat positions is determined automatically, and assigned to at least one state parameter. One of the seat positions may be assigned to the driver's seat position, another to a journey in intra-urban traffic, another to a freeway journey, another to a short-distance journey, another to a long-distance journey, and another to a driver action such as, for example, the activating of a smartphone. For the purpose of determining the type of journey, data of a navigation system of the vehicle can be evaluated, while data of an infotainment system or camera system of the vehicle can be evaluated, for example to ascertain whether the smartphone has been activated.

According to a further embodiment, at least one seat position of the plurality of seat positions is determined by evaluation of a driver's seat position. For example, by use of algorithms, a seat position for short-distance or long-distance journeys, or intra-urban journeys and freeway journeys, can be determined from the driver's seat position.

According to a further embodiment, at least one seat position of the plurality of seat positions is determined manually by a driver of the vehicle and assigned to at least one state parameter. The respective driver can thus individually define their preferred seat positions.

According to a further embodiment, a current seat position of the seat is altered progressively, in order to achieve a selected seat position from the plurality of seat positions. Abrupt transitions that could be irritating to the driver during travel are thus avoided.

According to a further embodiment, the selected seat position is determined from a current seat position. Thus, a seat position for short-distance or long-distance journeys, or for intra-urban journeys and freeway journeys, can be determined from a current seat position by use of algorithms.

According to another aspect of the present invention, a seat control device for altering a seat position of a seat of a vehicle is provided. The seat control device is designed to sense a state parameter and to determine a seat position for the seat, from a plurality of seat positions, in dependence on the state parameter, and to adjust the seat to the determined seat position.

According to a further aspect of the present invention, a seat for a vehicle is provided. The seat for a vehicle includes a control device for altering a seat position of a seat of the vehicle. The seat control device is designed to sense a state parameter and to determine a seat position for the seat, from a plurality of seat positions, in dependence on the state parameter and to adjust the seat to the determined seat position.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a schematic representation of a vehicle, according to an exemplary embodiment;

FIG. 2 is a schematic representation of a seat of the vehicle shown in FIG. 1 and having a control device for adjusting seat position; and

FIG. 3 is a flow diagram of an exemplary embodiment of a method for adjusting a seat of the vehicle represented in FIG. 1.

### DETAILED DESCRIPTION OF THE PREFERRED EMBODIMENTS

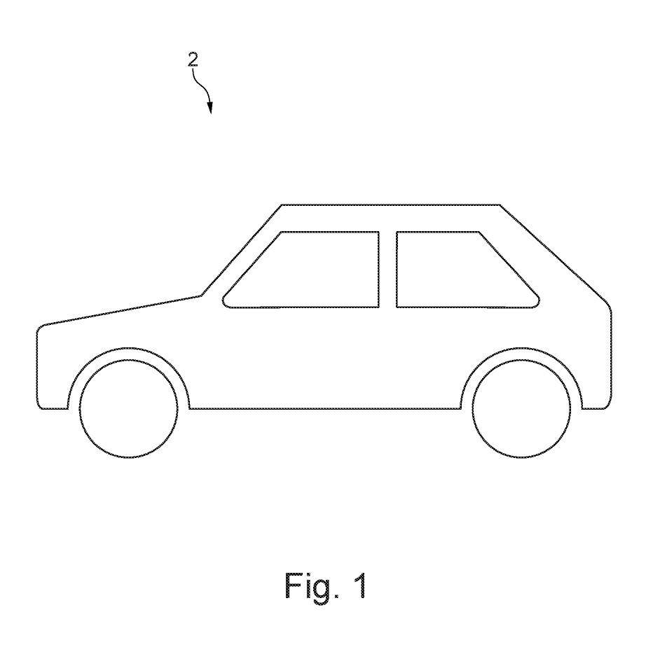

Referring to FIG. 1, a self-driving vehicle 2, which in the present exemplary embodiment is a passenger car is shown. In deviation from the present exemplary embodiment, the vehicle 2 may also be realized, for example, as a truck. Further, the vehicle 2 may also be an aircraft, train or ship or other vehicle that provides a means of transport. In deviation from the present exemplary embodiment example, the vehicle 2 may also be non-self-driving. A self-driving vehicle 2 in this case is understood to mean a vehicle that can travel, steer and park without the influence of a human driver (highly automated driving, or autonomous driving). By use of various sensors (not represented), the self-driving vehicle 2 can sense its environment and, from the information obtained, determine its position and that of other road users, travel to a destination by working in combination with the navigation software, and avoid collisions on the way to the destination.

In the present exemplary embodiment, the self-driving vehicle 2 may be a level 3 or 4 vehicle, according to the classification (inter alia SAE J3016) of autonomous travel. A level 3 vehicle is highly automated. This means that the driver does not need to continuously monitor the vehicle 2. The vehicle 2 independently performs functions such as activating the blinker, lane changing and lane keeping. The driver is able to attend to other matters, but if necessary is requested, by a requested driver intervention, within an advance warning time, to assume control. A level 4 vehicle is fully automated. The vehicle is continuously under the control of a system. If the driving tasks are no longer being accomplished, the driver may be requested, by a requested driver intervention, to assume control.

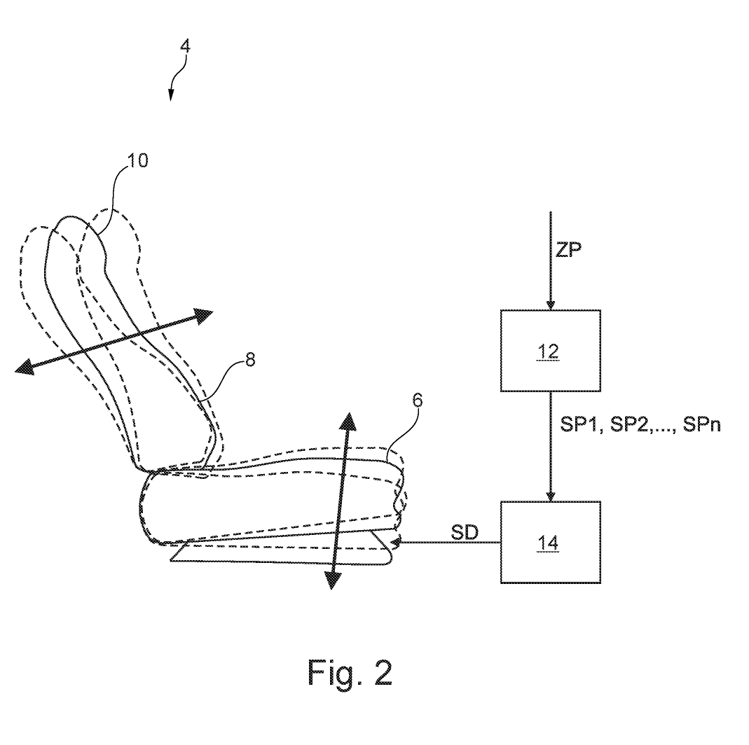

Reference is now additionally made to FIG. 2 which shows a seat 4 of the vehicle 2. In the present exemplary embodiment, the seat 4 is a driver's seat. However, the seat 4 may also be a front passenger's seat or a passenger's seat located in the rear of the vehicle.

In the present exemplary embodiment, the seat 4 has a seat surface 6, a backrest 8 and a head restraint 10, each of which are configured so as to be adjustable, for which purpose a drive such as, for example, an electric motor (not represented) is provided to make the adjustments in each case. In other words, the seat 4 has an electric seat adjustment.

The extent and differentiation of the electric seat adjustment depend to a large extent on the level of comfort and equipment of the respective vehicle 2. In the present exemplary embodiment, the seat 4 is configured with an electric seat adjustment that provides a 6-way adjustment, which allows the seat 4 as a whole to be shifted forward and backward on seat rails of the seat 4 to enable persons of differing body sizes to properly operate the pedals for acceleration, brake and, if appropriate, clutch of the vehicle 2. In addition, the present exemplary embodiment, the inclination of the backrest 8 forward and backward and the seat height up and down can be adjusted.

In deviation from the present exemplary embodiment, the seat 4 may be configured to have only a 2-way adjustment or 4-way adjustment. In the case of a 2-way adjustment, the seat 4 can only be shifted forward and backward, whereas, in the case of a 4-way seat adjustment, the seat 4 can be adjusted horizontally forward and backward, and the inclination of the backrest 8 can be adjusted forward and backward.

Furthermore, according to other embodiments, the seat 4 may also have a 10-way adjustment, a 12-way adjustment or a 16-way adjustment. The 10-way adjustment allows, for example, besides the longitudinal setting, adaptation of the seat height and depth, backrest inclination and lumbar support, whereas a 12-way adjustment allows, besides the longitudinal setting, adaptation of the seat height and depth, inclination of the seat surface and backrest, and lumbar support. Finally, an 18-way adjustment may provide, besides the longitudinal setting, adaptation of the seat height and depth, inclination of the seat surface and backrest, top of backrest and lumbar support, head restraint height and, in addition, the depth of the seat surface.

Alternatively, a 30-way or 32-way adjustment, or any combination of the respective individual setting possibilities, may also be provided. The adjustment possibilities may comprises six possibilities, for adapting a lower cushion of the seat 4 (forward/backward, raise/lower the front edge, raise/lower the rear edge of the cushion), and/or two possibilities for setting the backrest 8 (raise/recline), and/or four possibilities for setting the head restraint 10 (forward/backward, up/down), and/or two possibilities for adapting the upper-back support (inclination forward/backward), and/or four possibilities for setting the lower seat cushion extensions (two telescopic segments, which move independently forward/backward), and/or four possibilities for adapting thigh supports, and/or four possibilities for adapting the lumbar support (up/down, inflate/empty), and/or two possibilities for setting the backrest side cushions, and/or two possibilities for retracting and extending the lower seat cushions. Further, it may be provided that, besides the seat 4, the position of an arm-rest and/or a steering wheel position can be adapted accordingly. Furthermore, airbags of the seat 4, mirror settings, pedal positions, foot rest positions, foot support positions, table positions, device holder positions, neck region adjustments, or other setting possibilities can be adapted.

In addition, the seat 4 has a seat control device 12 and a seat controller 14 configured to control adjustments of the seat 4. The seat control device 12 and the seat controller 14 may have hardware and/or software components for the functions and/or tasks described in the following. The seat control device 12 is designed to sense a state parameter ZP and to determine a seat position SP1, SP2, . . . SPn for the seat 4 of the vehicle 2, from the plurality of seat positions SP1, SP2, . . . SPn, in dependence on the state parameter ZP.

The state parameter ZP may be representative of a driver intervention requested by the vehicle 2. Additionally or alternatively, the state parameter ZP may be representative of a traffic situation such as, for example, intra-urban traffic or a freeway journey, a travel duration such as, for example, a short distance or a long distance, or a driver action such as, for example, the activating of a smartphone.

The plurality of seat positions SP1, SP2, . . . SPn may differ, for example, in respect of the inclination of the backrest 8. One seat position of the plurality of seat positions SP1, SP2, . . . SPn is a driver's seat position, in which the driver controls the vehicle 2.

The seat control device 6 is configured, upon a requested driver intervention, to select the driver's seat position from the plurality of seat positions SP1, SP2, . . . SPn, if the vehicle 2 is travelling in a semi-automatic operating mode. Thus, the seat control device 6 may select and adjust the driver's seat position from a first position operable in the semi-automatic operating mode to a second position that allows the driver to drive or control the vehicle. This may comprise, for example, altering the inclination of the backrest 8, but also shifting the seat 4 as a whole forward and backward to enable the driver to properly operate the pedals for acceleration, brake and, if appropriate, clutch of the vehicle 2.

Starting from a current seat position of the seat 4, this position is changed progressively in order to achieve the selected seat position, e.g., the driver's seat position, from the plurality of seat positions SP1, SP2, . . . SPn. For this purpose, the seat control device 12 transmits the selected seat position, from the plurality of seat positions SP1, SP2, . . . SPn, to the seat controller 14, which then activates the respective drive, for example, to adjust the seat height of the seat surface 6, the inclination of the backrest 8 and the head restraint 10. For this purpose, the seat controller 14 generates control data SD.

The individual seat positions of the plurality of seat positions SP1, SP2, . . . SPn may be set manually, e.g., by the driver, and stored, and assigned to a respective state parameter ZP. Thus, for example, one seat position of the plurality of seat positions SP1, SP2, . . . SPn may be assigned to the driver's seat position, another to travel in intra-urban traffic, another to freeway travel, another to a short-distance journey, another to a long-distance journey, and another to a driver action such as, for example, the activation of a smartphone. For the purpose of determining the type of journey, data of a navigation system of the vehicle 2 can be evaluated, while data of an infotainment system of the vehicle can be evaluated, for example to ascertain whether the smartphone has been activated.

Further, seat positions of the plurality of seat positions SP1, SP2, . . . SPn may be determined automatically and assigned to a state parameter ZP. For the purpose of automatically determining a seat position of the plurality of seat positions SP1, SP2, . . . SPn, the driver's seat position or a current seat position, for example, may be evaluated. For example, a seat position for short-distance or long-distance journeys, or for intra-urban journeys and freeway journeys, may be determined from the driver's seat position.

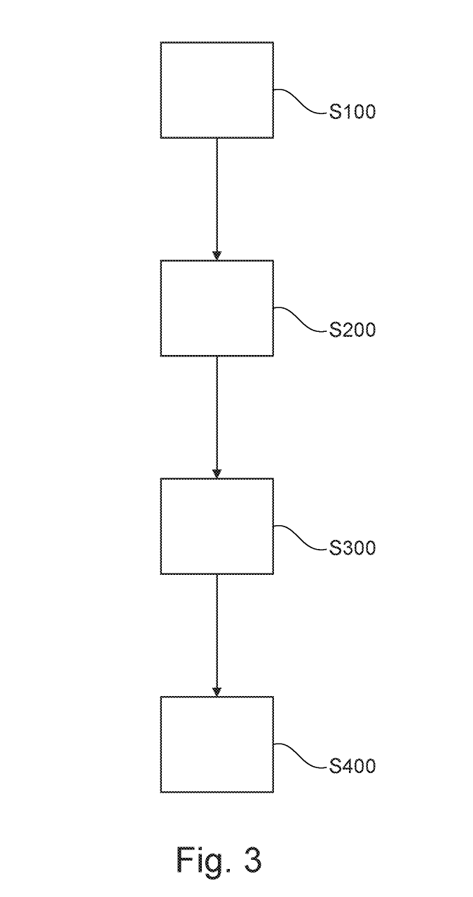

Referring now additionally to FIG. 3, when in operation, the seat control device 12, in a first step S100, senses the state parameter ZP and selects a seat position, from a plurality of seat positions SP1, SP2, . . . SPn, in dependence on the state parameter ZP. If, for example, the vehicle 2 is travelling autonomously in a semi-automatic operating mode, and the sensed state parameter ZP is representative of a requested driver intervention, i.e., the driver is to assume control of the vehicle 2, in a further step S200 the seat control device 12 selects the predetermined driver's seat position from the plurality of seat positions SP1, SP2, . . . SPn.

Then, in a further step S300, the seat control device 12 transmits the selected seat position, from the plurality of seat positions SP1, SP2, . . . SPn, to the seat controller 14, which thereupon, in a further step S400, determines the respective control data SD for activating the respective drive for adjusting the seat height of the seat surface 6, the inclination of the backrest 8 and the head restraint 10, in order progressively to achieve the driver's seat position, starting from the current seat position.

Thus, by sensing and evaluation of the state parameter, a seat position adapted to the respective situation can be provided.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A method for adjusting a seat of a vehicle comprising the steps of:
sensing a state parameter;
selecting a seat position for the seat from a plurality of seat positions, in dependence on the state parameter; and
adjusting the seat to the selected seat position.

2. The method as claimed in claim 1, wherein the state parameter is representative of at least one of a requested driver intervention, a traffic situation, a journey duration, and a driver action.

3. The method as claimed in claim 1 further comprising the steps of operating the vehicle to travel in a semiautomatic operating mode and, upon a requested driver intervention, selecting a driver's seat position from the plurality of seat positions.

4. The method as claimed in claim 1, wherein at least one seat position of the plurality of seat positions is determined automatically, and assigned to at least one state parameter.

5. The method as claimed in claim 1, wherein at least one seat position of the plurality of seat positions is determined by evaluation of a driver's seat position.

6. The method as claimed in claim 1, wherein at least one seat position of the plurality of seat positions is determined manually by a driver of the vehicle and assigned to at least one state parameter.

7. The method as claimed in claim 1 further comprising the step of progressively altering a current seat position of the seat in order to achieve a selected seat position from the plurality of seat positions.

8. The method as claimed in claim 1, wherein the selected seat position is determined from a current seat position.

9. A seat control device for altering a seat position of a seat of a vehicle, wherein the seat control device is configured to sense a state parameter and to determine a seat position for the seat, from a plurality of seat positions, in dependence on the state parameter, and to adjust the seat to the determined seat position.

10. The seat control device as claimed in claim 9, wherein the state parameter is representative of at least one of a driver intervention, a traffic situation, a travel duration, and a driver action.

11. The seat control device as claimed in claim 9, wherein the seat control device is configured upon a requested driver intervention, to select a driver's seat position from the plurality of seat positions, if the vehicle is travelling in a semi-automatic operating mode.

12. The seat control device as claimed in claim 9, wherein the seat control device is configured to determine automatically at least one seat position of the plurality of seat positions and to assign it to at least one state parameter.

13. The seat control device as claimed in claim 9, wherein the seat control device is configured to determine at least one seat position of the plurality of seat positions by evaluating a driver's seat position.

14. The seat control device as claimed in claim 9, wherein the seat control device is configured to determine manually at least one seat position of the plurality of seat positions by a driver of the vehicle and to assign it to at least one state parameter.

15. The seat control device as claimed in claim 9, wherein the seat control device is configured to progressively change a current seat position of the seat in order to achieve a selected seat position from the plurality of seat positions.

16. The seat control device as claimed in claim 9, wherein the seat control device is configured to determine the selected seat position from a current seat position.

17. A seat for a vehicle comprising:
a control device for altering a seat position of a seat of the vehicle, wherein the seat control device is configured to sense a state parameter and to determine a seat position for the seat, from a plurality of seat positions, in dependence on the state parameter and to adjust the seat to the determined seat position.

18. The seat for a vehicle as claimed in claim 17 further comprising a computer program for controlling the seat.

19. The seat for a vehicle as claimed in claim 17, wherein the state parameter is representative of at least one of a requested driver intervention, a traffic situation, a journey duration, and a driver action.

20. The seat for a vehicle as claimed in claim 17, wherein the vehicle travels in a semiautomatic operating mode and, upon a requested driver intervention, the control device selects a driver's seat position from the plurality of seat positions.
